(19) United States
(12) Patent Application Publication
(10) Pub. No.: US 2025/0075896 A1
(43) Pub. Date: Mar. 6, 2025

(54) Screen illumination device

(71) Applicant: CHAMP VISION DISPLAY INC., MIAO-LI COUNTY (TW)

(72) Inventors: KUO-LUNG LIN, MIAO-LI COUNTY (TW); CHIN-KU LIU, MIAO-LI COUNTY (TW); HSIN-HUNG LEE, MIAO-LI COUNTY (TW)

(21) Appl. No.: 18/814,631

(22) Filed: Aug. 26, 2024

(30) Foreign Application Priority Data
Aug. 31, 2023 (CN) 202311113267.7

(51) Int. Cl. F21V 33/00; F21V 8/00; F21V 11/16; F21Y 113/00

(52) U.S. Cl. CPC F21V 33/0052; F21V 11/16; G02B 6/0068; G02B 6/0088; F21Y 2113/00

(57) ABSTRACT

A screen illumination device includes a body, a first light source, and a second light source. The body includes a first housing and a second housing. The second housing is detachably connected to the first housing. The first light source is connected to the body and adapted to generate a first light beam. The second light source is connected to the body and adapted to generate a second light beam. The first housing is adapted to allow the first light beam to emit out along a first direction, the second housing is adapted to allow the second light beam to emit out along a second direction, and the second direction is different from the first direction.

### CROSS-REFERENCE TO RELATED APPLICATION

This application claims the priority benefit of China Application No. 202311113267.7, filed on Aug. 31, 2023. The entirety of the above-mentioned patent application is hereby incorporated by reference herein and made a part of this specification.

### FIELD OF THE DISCLOSURE

The present disclosure relates to the field of illumination, and more particularly to an illumination device installed on a screen.

### BACKGROUND OF THE DISCLOSURE

In order to obtain comfortable illumination while reading, desk lamps are the most common source of desktop illumination. However, as computers become more and more popular, in addition to desk lamps, readers need to place computer-related equipment such as screens, keyboards, mice, etc., making the space on the desktop smaller.

Therefore, there is currently a lamp that is installed on the screen, which saves space on the desktop by using the screen as a bracket for the lamp. In order to avoid using traditional light bulbs to block the screen or be too heavy and change the center of gravity of the screen, most of these lamps use smaller and lighter light-emitting components as light sources to facilitate a better flexibility in design.

The information disclosed in this “BACKGROUND OF THE DISCLOSURE” section is only for enhancement understanding of the background of the disclosure and therefore it may contain information that does not form the prior art that is already known to a person of ordinary skill in the art. Furthermore, the information disclosed in this “BACKGROUND OF THE DISCLOSURE” section does not mean that one or more problems to be solved by one or more embodiments of the disclosure were acknowledged by a person of ordinary skill in the art.

### SUMMARY OF THE DISCLOSURE

The present disclosure provides a screen illumination device that can provide two types of illumination emitting in different directions, and the users can change the illumination style according to needs.

Other advantages and objectives of the disclosure may be further illustrated by the technical features broadly embodied and described as follows.

In order to achieve one or a portion of or all of the objectives or other objectives, the screen illumination device provided by the disclosure includes a body, a first light source, and a second light source. The body includes a first housing and a second housing. The second housing is detachably connected to the first housing. The first light source is connected to the body and adapted to generate a first light beam. The second light source is connected to the body and adapted to generate a second light beam. The first housing is adapted to allow the first light beam to emit out along a first direction, the second housing is adapted to allow the second light beam to emit out along a second direction, and the second direction is different from the first direction.

As can be seen from the above description, in addition to providing the first light beam in the first direction through the first housing, the screen illumination device of the present disclosure also generates the second light beam emitting in the second direction through the second housing that can be detachably connected to the first housing. Therefore, the screen illumination device of the present disclosure can provide two types of illumination emitting in different directions, and the users can change the illumination style according to their needs.

Other objectives, features and advantages of the invention will be further understood from the further technological features disclosed by the embodiments of the invention wherein there are shown and described preferred embodiments of the present disclosure, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of the assembly of a screen illumination device according to an embodiment of the present disclosure;

FIG. 2A is an exploded view of the screen illumination device of FIG. 1;

FIG. 2B is a schematic cross-sectional view of the assembled screen illumination device in the embodiment of FIG. 1;

FIG. 3A is a schematic diagram of the assembly of a screen illumination device according to another embodiment of the present disclosure;

FIG. 3B is a schematic cross-sectional view of an assembled screen illumination device according to another embodiment of the present disclosure, wherein the structure of the second housing in FIG. 3B is similar to that in the embodiment of FIG. 3A;

FIG. 4 is a schematic cross-sectional view of the installation location of the second housing in another embodiment of the present disclosure; and

FIG. 5 is a schematic cross-sectional view of a screen illumination device in another embodiment of the present disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

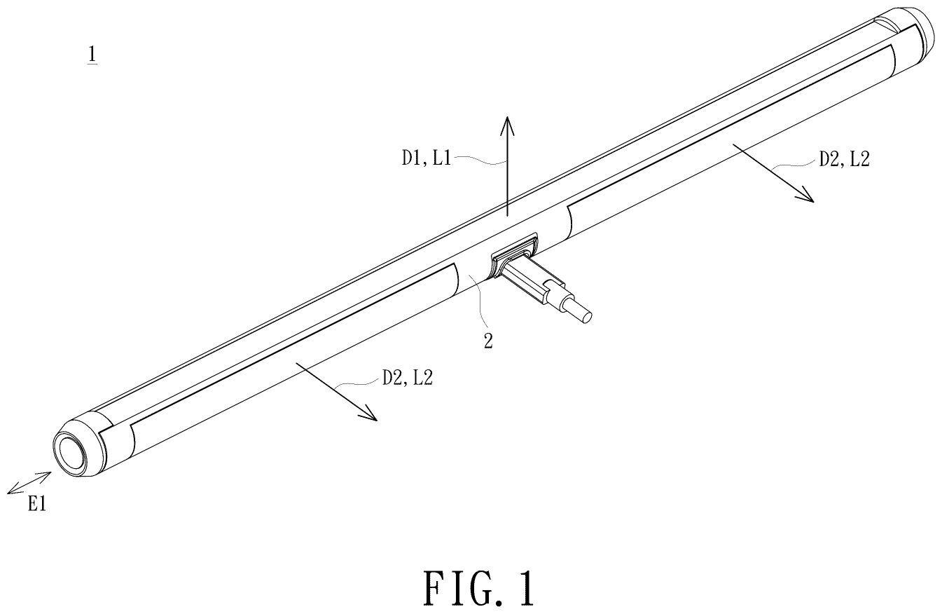

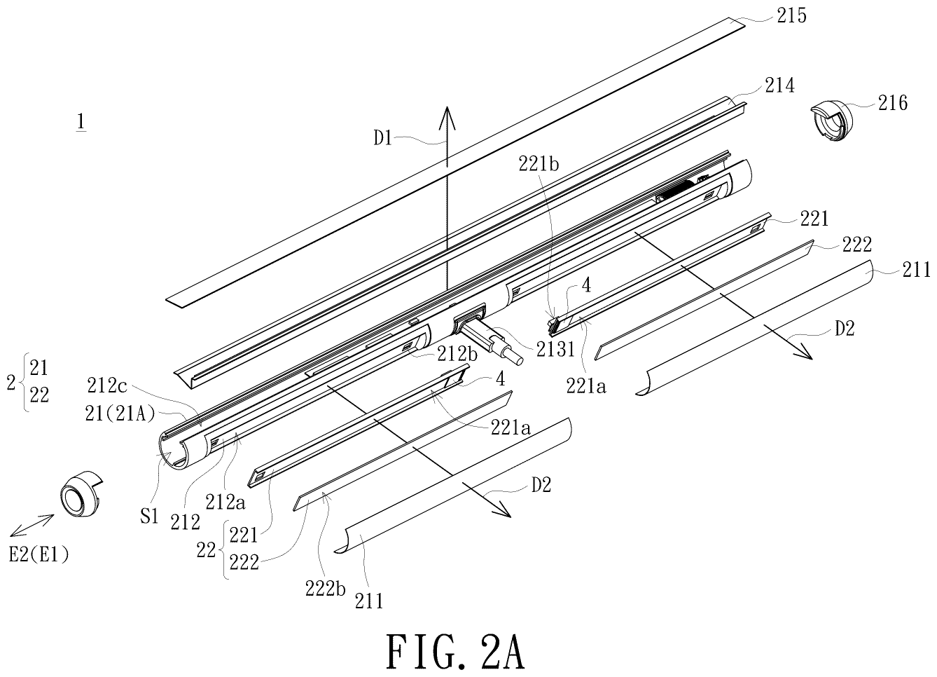

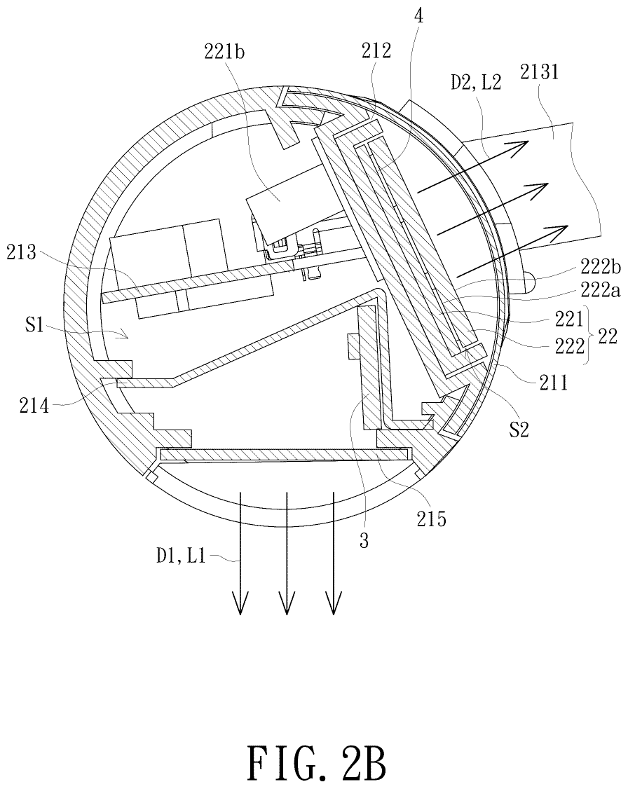

FIG. 1 is a schematic diagram of the assembly of a screen illumination device according to an embodiment of the present disclosure. FIG. 2A is an exploded view of the screen illumination device of FIG. 1. FIG. 2B is a schematic cross-sectional view of the assembled screen illumination device in the embodiment of FIG. 1.

As shown in FIGS. 1 to 2B, the screen illumination device 1 according to an embodiment of the present disclosure includes a body 2, a first light source 3, and a second light source 4. The body 2 includes a first housing 21 (see FIG. 2A) and a second housing 22 (see FIG. 2A). The second housing 22 is detachably connected to the first housing 21. The first light source 3 (see FIG. 2B) is connected to the body 2 and is adapted to generate a first light beam L1. The second light source 4 is connected to the body 2 and is adapted to generate a second light beam L2. The first housing 21 is adapted to allow the first light beam L1 to emit from the first housing 21 in the first direction D1, the second housing 22 is adapted to allow the second light beam L2 to emit from the second housing 22 in the second direction D2, and the second direction D2 is different from the first direction D1.

Specifically, as shown in FIG. 1, the body 2 has a strip shape, for example. During installation, the body 2 is installed on the upper edge of the screen (not shown) through a hanger (not shown), and a long axis direction E1 of the body 2 is, for example, parallel to the upper edge of the screen. The body 2 can, for example, rotate relative to the hanger with the long axis direction E1 of the body 2 as the axis, so that the first direction D1 defined by the first housing 21 and the second direction D2 defined by the second housing 22 can rotate relative to the screen.

As shown in FIGS. 2A and 2B, in this embodiment, the first housing 21 includes, for example, a shell 21A, an accommodation groove 212, and a first accommodation cavity S1. Specifically, in this embodiment, the shell 21A forms the first accommodation cavity S1 and two accommodation grooves 212. The first accommodation cavity S1 and the accommodation grooves 212 are respectively located on opposite sides of the shell 21A, and the accommodation grooves 212 are respectively arranged along a long axis direction E2 of the shell 21A. Specifically, the first accommodation cavity S1 and each the accommodation grooves 212 are not connected, and it means that the first accommodation cavity S1 and each the accommodation grooves 212 are separated by the shell 21A. The shell 21A has, for example, a first opening 212c. The first opening 212c is located on the first direction D1 and communicates with the first accommodation cavity S1. The accommodation groove 212 is, for example, a rectangular groove body inwardly concave toward the first accommodation cavity S1 of the shell 21A on the second direction D2. The accommodation groove 212 has a bottom surface 212a formed by the shell 21A. The accommodation groove 212 accommodates the second housing 22 when the first housing 21 and the second housing 22 are combined and is connected to the second housing 22 via, for example, an insertion hole 212b arranged on the bottom surface 212a.

The shape of the accommodation groove 212 is not limited to the above example. In other embodiments not shown, the accommodation groove 212 formed on the shell 21A may, for example, be composed by an opening communicating with the first accommodation cavity S1, and the second housing 22 can be a housing arranged for being clamped at the periphery of the opening (accommodation groove 212). In other words, the relative position of the first accommodation cavity S1 and the accommodation groove 212 can be changed, and the shape of the accommodation groove 212 is not limited to the above examples.

As shown in FIG. 2A and FIG. 2B, in this embodiment, the body 2 further includes a light-transmitting plate 211, for example. The shape of the light-transmitting plate 211 corresponds to a shape of an opening of the accommodation groove 212. The light-transmitting plate 211 is used to cover the accommodation groove 212 and the second housing 22 and faces the second direction D2 after the second housing 22 is installed in the accommodation groove 212.

The first light source 3 is located in the first accommodation cavity S1. The first light source 3 is, for example, a light bar. The light bar has, for example, a plurality of light-emitting diodes (LEDs). The light-emitting diodes are, for example, arranged in the first accommodation cavity S1 along the long axis direction E1 of the body 2. The light-emitting diodes together generate the first light beam L1 used as illumination light, and the color of the illumination light is, for example, white, but the color and type of the first light source 3 are not limited to this.

As shown in FIGS. 2A and 2B, in this embodiment, the screen illumination device 1 may further include a circuit board 213 (see FIG. 2B), a reflector 214, and a diffusion plate 215. The circuit board 213 is located in the first accommodation cavity S1. The circuit board 213 obtains external power through, for example, a connector 2131 arranged to pass through the center of the first housing 21 and controls the action of the first light source 3 (such as but not limited to controlling the luminous intensity or color temperature) with a button 216 and a turntable (not shown, electrically connected to the circuit board 213) installed on the first housing 21. The reflector 214 is located in the first accommodation cavity S1 and is located on the light path of the first light source 3. The diffusion plate 215 is disposed, for example, to cover the entire first opening 212c. However, the specific types or shape designs of the components related to the first housing 21 are not limited to the above examples.

As shown in FIG. 2A and FIG. 2B, in this embodiment, the body 2 has, for example, two second housings 22. Each second housing 22 has, for example, a second accommodation cavity S2 (see FIG. 2B). Because the detailed structures of the two second housings 22 are the same, just the design of one of the second housings 22 will be described below. Specifically, the second housing 22 includes, for example, a support plate 221 and a cover plate 222, wherein the support plate 221 and the cover plate 222 are located in the second accommodation cavity S2. The support plate 221 is, for example, a U-shaped plate extending along the long axis direction E1 of the body 2 and has a second opening 221a that opens toward the second direction D2. The cover plate 222 covers the second opening 221a and forms the second housing 22 together with the support plates 221.

In this embodiment, the second light source 4 is located in the second accommodation cavity S2, and the second light beam L2 is emitted from the second opening 221a through the cover plate 222. The second light source 4 is, for example, a light-emitting module capable of changing the color of the second light beam L2 and has, for example, a plurality of light-emitting diodes (not shown) for generating light beams of different colors. The aforementioned light-emitting diodes include, for example, the red, blue, and green light-emitting diodes and can mix these colors through differences in luminous intensity to generate the second light beams L2 of different colors. In other words, in this embodiment, the color of the second light beam L2 generated by the second light source 4 can be changed by a control circuit (not shown), but the detailed type and function of the second light source 4 are not limited to the above.

In terms of electrical connection, the support plate 221 includes, for example, a connecting part 221b on a side away from the second accommodation cavity S2. One end of the connecting part 221b is electrically connected to the second light source 4. The other end protrudes from the surface of the support plate 221 away from the second opening 221a, passes through the insertion hole 212b on the the accommodation groove 212 of the shell 21A, and extends into the first housing 21 for electrical connection with the circuit board 213. With this structure, the user can control the lighting mode of the second light source 4 through a button (not shown) or knob (not shown) arranged on the first housing 21, but the disclosure is not limited to this.

In this embodiment, the second light source 4 and the cover plate 222 are arranged along the second direction D2. The cover plate 222 is, for example, a diffusion plate. The cover plate 222 has a light incident surface 222a and a light exit surface 222b. The light incident surface 222a faces the second light source 4. The second light beam L2 passes through the cover plate 222 and emits out through the second opening 221a, but is not limited thereto. In another embodiment, the cover plate 222 is, for example, a light guide plate, the second light source 4 emits the second light beam L2 along the long axis direction E1 of the body 2, and the second light source 4 and the cover plate 222 are arranged along the long axis direction E1 of the body 2. The cover plate 222 has a light incident surface and a light exit surface (not shown). The light incident surface faces the second light source 4, and the light exit surface determines the second direction D2. The specific types or shape designs of the components related to the second housing 22 are not limited to the above examples, and please refer to the following description for details. It should be understood that because the quantity of the second housing 22 and the second light source 4 corresponds to the quantity of the accommodation grooves 212, the screen illumination device 1 may have only one second housing 22 and one second light source 4 in other embodiments not shown.

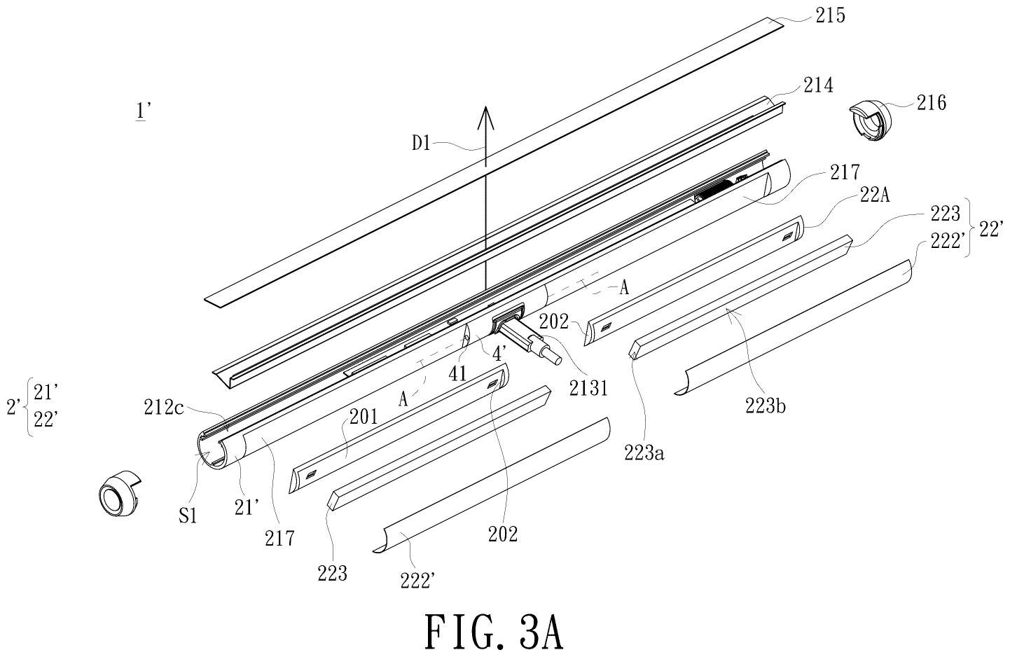

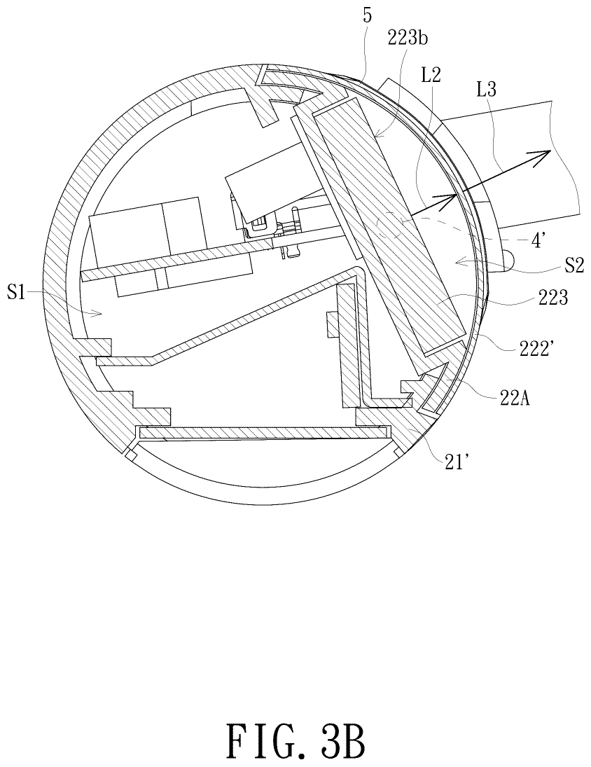

FIG. 3A is a schematic diagram of the assembly of a screen illumination device according to another embodiment of the present disclosure. FIG. 3B is a schematic cross-sectional view of an assembled screen illumination device according to another embodiment of the present disclosure. In the screen illumination device 1′ of this embodiment, the structure of the first housing 21′ can be substantially the same as that of the previous embodiment, so only the differences will be described here. In addition, because the two second housings 22′ in this embodiment have the same structure, just the structure of one of the second housings 22′ will be described below.

As shown in FIG. 3A, different from the embodiment of FIG. 2A, the first housing 21′ in this embodiment, in addition to the first accommodation cavity S1, further includes two combination parts 217 and does not have the accommodation groove 212. The two combination parts 217 are adapted to assemble the second housing 22′. The shape of the combination part 217 is, for example, but not limited to, similar to the accommodation groove 212 in the previous embodiment, and the two combination parts 217 are arranged along the long axis direction E1 of the first housing 21′, but the detailed shape of the combination part 217 is not limited to this. For example, in FIG. 3B, the combination part 217 may be an opening (not labeled because it is covered by the second housing 22′).

As shown in FIG. 3A, in this embodiment, the first housing 21′ has an axis A along the long axis direction. The extension direction of the axis A is different from the first direction D1 and the second direction D2. For example, the extension direction of the axis A is parallel to the long axis direction E1 of the body 2′. The second light source 4′ is disposed on the first housing 21′ and located outside the first accommodation cavity S1. The quantity of the second light source 4′ may be, for example, one and is disposed between the two combination parts 217. The second light source 4′ has openings 41 facing the combination parts 217 on both sides respectively. In other words, the two combination parts 217 and the first accommodation cavity S1 are separated by the shell 21A′ (not shown), and the two combination parts 217 are located outside the first accommodation cavity S1 and are respectively located on the different sides of the second light source 4′ along the axis A. When activated, the second light beam L2 generated by the second light source 4′ emits toward the two combination parts 217 directly or through the openings 41 along different directions of the axis A, but is not limited thereto. In another embodiment, there may be a plurality of second light sources 4′. The second light sources 4′ are disposed on the first housing 21′, located outside the first accommodation cavity S1, and disposed respectively corresponding to the two combination parts 217. That is, when activated, the second light beam L2 generated by each second light source 4′ emits toward the corresponding combination part 217 directly or through the opening 41 along the axis A.

In this embodiment, the second housing 22′ includes, for example, a shell 22A, a light-transmitting plate 222′, and a light guide plate 223. The shell 22A surrounds to form a groove body 201 similar to the accommodation groove 212. The light-transmitting plate 222′ covers the opening of the groove body 201 and forms the second accommodation cavity S2 together with the groove body 201. The second accommodation cavity S2 (i.e., on the side of the groove body 201) has a light-transparent light-incident part 202 (see FIG. 3A). The light-incident part 202 is, for example, a light-transparent part of the shell 22A or a hole. During assembly, the light guide plate 223 is fixed in the second accommodation cavity S2, and the light incident surface 223a of the light guide plate 223 faces the light incident part 202. When the second housing 22′ is assembled to the combination part 217, the light incident part 202 faces the second light source 4′, and the second light beam L2 of the second light source 4′ is adapted to enter the second housing 22′ through the light incident part 202.

Through the above structure, the light incident part 202 is located on the axis A when the first housing 21′ and the two second housings 22′ are assembled. When the second light source 4′ generates the second light beam L2, the second light beam L2 is emitted to the light incident part 202 on the second housing 22′ along the axis A, then emitted to the light incident surface 223a of the light guide plate 223, and then emitted out the light exit surface 223b of the light guide plate 223 along the second direction D2.

In this embodiment, the screen illumination device 1′ further includes a pattern-generating element 5. The pattern-generating element 5 is connected to the second housing 22′ and is disposed on the transmission path of the second light beam L2. The pattern-generating element 5 is adapted to convert the second light beam L2 into a pattern light beam L3. Specifically, the pattern-generating element 5 in this embodiment is, for example, a light-shielding pattern provided on the light-transmitting plate 222′. When the second light beam L2 passes through the light-transmitting plate 222′, a part of the second light beam L2 is blocked by the pattern-generating element 5 to generate a pattern light beam L3 corresponding to the shape of the light-shielding pattern.

In other embodiments not shown, the pattern-generating element 5 may be a filter pattern including a plurality of different color parts. After passing through the light-transmitting plate 222′, a part of the second light beam L2 passing through the filter pattern becomes a patterned light beam with different colors. In addition, in one embodiment, the light-transmitting plate 222′ itself can be used as the pattern-generating element 5. Specifically, a portion of the light-transmitting plate 222′ can be formed with a plurality of lenses, through which a part of the second light beam L2 is biased to generate patterns, thereby making the patterns diverse. In addition, in other embodiments similar to the embodiment of FIG. 3A, the pattern-generating element 5 can be disposed on the light exit surface 223b of the light guide plate 223, such as a microstructure on the light guide plate 223. Thus, the desired pattern can be presented in the emitted light through the distribution of the microstructure. Or, in other embodiments similar to the embodiment of FIG. 2A, the pattern-generating element 5 can be disposed on the light exit surface 222b of the cover plate 222, such as a microstructure on the cover plate 222. It should be understood that in different embodiments, the arrangement or configuration of the pattern-generating element 5 is not limited to the above examples.

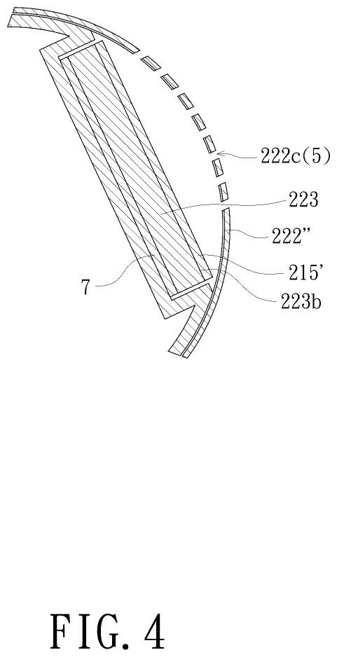

FIG. 4 is a schematic cross-sectional view of the installation location of the second housing in another embodiment of the present disclosure. In this embodiment, the first housing (not shown) in this embodiment can have the same design as the first housing in the embodiment of FIG. 3A, but the detailed design of the second housing 22″ can be changed. Only the changed parts will be described below.

As shown in FIG. 4, in this embodiment, the light exit surface 223b of the light guide plate 223 is covered with a diffusion plate 215′, the contact surface between the light guide plate 223 and the second housing 22″ is provided with a reflective layer 7, and the light-transmitting plate 222′ has a plurality of light-transmitting holes 222c, for example. In a similar embodiment, the light-transmitting holes 222c can be arranged in a pattern and serve as the pattern-generating element 5, but are not limited to this.

As can be seen from the above examples, the detailed structure of the second housing in various embodiments of the present disclosure can be changed according to the position of the second light source. The user can change the detailed structure of the second housing according to the needs of arrangements or generating pattern light beams.

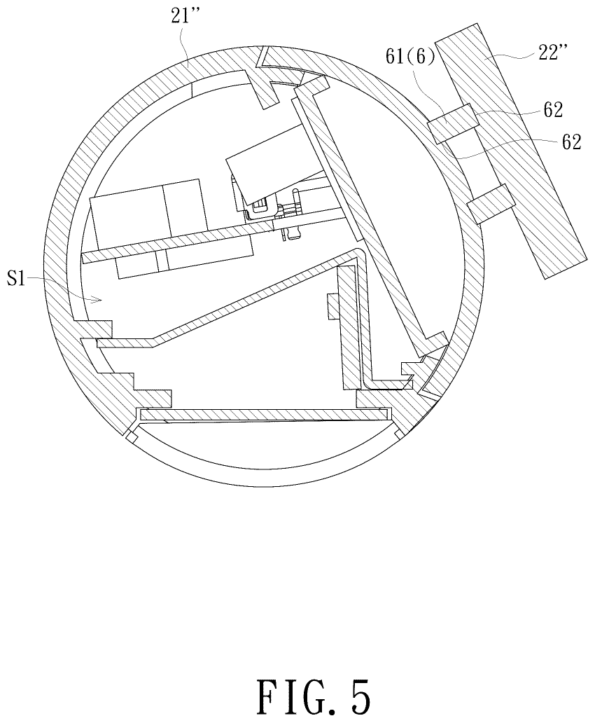

FIG. 5 is a schematic cross-sectional view of a screen illumination device in another embodiment of the present disclosure. Please refer to FIG. 5. In this embodiment, the screen illumination device 1″ further includes a bracket part 6. The first housing 21″ and the second housing 22″ (for convenience of illustration, the detailed structure is not drawn) are connected through the bracket part 6. As shown in FIG. 5, specifically, the bracket part 6 is composed of a plurality of plug pins 61, and the first housing 21″ and the second housing 22″ can be provided with holes 62 corresponding to the plug pins 61, but are not limited to this. It should be understood that the shape of the bracket part 6 can be changed according to needs. In some embodiments, the connection position or angle between the bracket part 6 and the second housing 22″ can be changed. In other words, the bracket part 6 can have a rotating shaft (not shown) by changing the connection position or direction between the bracket part 6 and the second housing 22″ or even changing the design of the bracket part 6, thereby changing the second direction D2 where the second housing 22″ faces.

As can be seen from the above description, in addition to providing the first light beam in the first direction through the first housing, the screen illumination device of the present disclosure also generates the second light beam emitting in the second direction through the second housing that can be detachably connected to the first housing. Therefore, the screen illumination device of the present disclosure can provide two types of illuminations emitting in different directions, and the users can change the illumination style according to their needs.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the terms “the invention”, “the disclosure” or the like is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A screen illumination device, comprising:
a body, comprising a first housing and a second housing, wherein the second housing is detachably connected to the first housing;
a first light source, connected to the body and adapted to generate a first light beam; and
a second light source, connected to the body and adapted to generate a second light beam;
wherein the first housing is adapted to allow the first light beam to emit out along a first direction, the second housing is adapted to allow the second light beam to emit out along a second direction, and the second direction is different from the first direction.

2. The screen illumination device according to claim 1, wherein the first housing comprises a first accommodation cavity, the first light source is located in the first accommodation cavity, the second housing comprises a second accommodation cavity, and the second light source is located in the second accommodation cavity.

3. The screen illumination device according to claim 2, further comprising a bracket part, wherein the first housing and the second housing are connected through the bracket part.

4. The screen illumination device according to claim 2, wherein the first housing further comprises a shell and an accommodation groove, the shell forms the first accommodation cavity and the accommodation groove, the first accommodation cavity and the accommodation groove are respectively located on opposite sides of the shell, and the second housing is adapted to be accommodated in the accommodation groove.

5. The screen illumination device according to claim 1, wherein the first light source and the second light source are disposed in the first housing, the first housing comprises a first accommodation cavity and a combination part, the first light source is located in the first accommodation cavity, the second light source is disposed outside the first accommodation cavity, the combination part is located outside the first accommodation cavity and is located on a side of the second light source, the combination part is adapted to assemble with the second housing, the second housing comprises a light incident part, the light incident part faces the second light source when the second housing is assembled with the combination part, and the second light beam of the second light source is adapted to enter the second housing through the light incident part.

6. The screen illumination device according to claim 5, wherein the first housing has an axis, an extension direction of the axis is different from the first direction and the second direction, the second light source emits the second light beam along the axis, and the light incident part is located on the axis when the first housing and the second housing are assembled.

7. The screen illumination device according to claim 5, further comprising a light guide plate, wherein the light guide plate has a light incident surface and a light exit surface, the second housing has a second accommodation cavity, the light incident part is located on a side of the second accommodation cavity, the light guide plate is fixed in the second accommodation cavity, the light incident surface faces the light incident part, and the light exit surface faces the second direction.

8. The screen illumination device according to claim 1, wherein the body further comprises a light-transmitting plate, and the second light beam is emitted from the light-transmitting plate along the second direction.

9. The screen illumination device according to claim 8, wherein the light-transmitting plate further has a plurality of light-transmitting holes.

10. The screen illumination device according to claim 1, further comprising a pattern-generating element, wherein the pattern-generating element is connected to the second housing and disposed on a transmission path of the second light beam, and the pattern-generating element is adapted to convert the second light beam into a patterned light beam.
